(19) United States
(12) Patent Application Publication
(10) Pub. No.: US 2003/0114102 A1
(43) Pub. Date: Jun. 19, 2003

(54) System and method for providing trans-polar satellite communications

(76) Inventor: Leonard S. Golding, Potomac, MD (US)

Correspondence Address: Hughes Electronics Corporation, Patent Docket Administration, Bldg. 1, Mail Stop A109, P.O. Box 956, El Segundo, CA, 90245-0956, US

(21) Appl. No.: 10/017,975

(22) Filed: Dec. 13, 2001

(51) Int. Cl. H04B 7/185

(52) U.S. Cl. 455/12.1; 455/13.1

(57) ABSTRACT

A system and method for providing trans-polar satellite communications is provided. The satellite communication system comprises at least one gateway station, at least one satellite having a polar orbit, and at least one antenna connected to the at least one gateway station for tracking the at least one satellite. The at least one satellite is adapted to provide single hop transpolar satellite communication between two gateways separated by as much as 180° in longitude. Additional satellites can be provided to provide global coverage. Each satellite provides trans-polar coverage of the earth for a time period dependent on the number of satellites used for coverage.

### BACKGROUND OF THE INVENTION

1. Field of the Invention

The present invention relates to a system and method for providing trans-polar satellite communications in a communications system. Specifically, the invention relates to a method and apparatus for providing single hop transpolar communication between any two locations on the earth via satellite communication, with end-to-end propagation delays less than 300 milliseconds. These two locations can be anywhere in the northern hemisphere or in the southern hemisphere as long as they have a latitude of at least ten degrees.

2. Description of the Related Art

Novel communications and/or navigation systems by means of satellite are making use of satellites that are in non-geostationary orbits, e.g. satellites in low earth orbit (LEO), or satellites in medium earth orbits or highly elliptical orbits (MEO, HEO, . . . ). These orbits may be circular or elliptical, and may require implementing a large number of such satellites in order to ensure complete coverage of a geographical zone of interest which is generally worldwide or multi-regional. In such systems, the satellites are generally all in similar orbits, i.e. orbits having the same altitude and the same inclination.

However, conventional satellite communication coverage for both geostationary and non-geostationary satellite systems require at a minimum double hop communications, for many locations separated by more than one-third of the earth. For example, for communication between Beijing, China and New York, USA, a satellite with coverage of the United States is required and a second satellite with coverage of the Pacific Ocean is also required. When a caller in the US places a call to China, the call is routed via the first satellite which comprises a first hop and then via the second satellite which comprises a second hop in order to complete this double hop one location must be capable of communicating with both satellites. Since resources are limited, communication via satellite is expensive compared to conventional landline communication. Thus with each hop, the cost of satellite communication increases. Furthermore, the end-to-end delay is doubled compared to a single hop connection, as well as other performance measures being poorer due to the double hop.

Conventional landline systems also encounter problems when confronted with intercontinental communication. Presently, intercontinental communication is handled by undersea and/or international land cable connections, which is very expensive to a subscriber. For example, data subscribers pay for usage based on the distance between locations, and/or the length of time of the connection.

Thus, there is a need for an intercontinental communication system that can provide global coverage with only a single hop between any two locations on earth that are located at least ten degrees in latitude from the equator.

### SUMMARY OF THE INVENTION

These and other objects are substantially achieved by a system and method utilizing a satellite communication system in accordance with the principles of the present invention. The satellite communication system comprises at least two earth stations in different locations, at least one satellite having a polar orbit, and at least one antenna at one earth station tracking the at least one satellite so as to be connected to at least the second earth also satellite tracking at least one. The at least one satellite is adapted to provide single hop communication between two earth stations separated by as much as 180° in longitude.

### BRIEF DESCRIPTION OF THE DRAWINGS

The details of the present invention can be readily understood by considering the following detailed description in conjunction with the accompanying drawings, and with:

FIG. 1 depicts a non-geosynchronous satellite communication system for providing single hop communication service in accordance with an embodiment of the present invention;

FIG. 2 depicts a trace of a transpolar satellite in accordance with an embodiment of the present invention;

FIG. 3 depicts a ground trace of a transpolar satellite in accordance with an embodiment of the present invention;

FIG. 4 depicts a hand-off diagram of a transpolar constellation in accordance with an embodiment of the present invention;

FIG. 5 depicts a graph illustrating a range of elevation angles compared to longitudinal angles in accordance with an embodiment of the present invention;

FIG. 6 depicts a graph illustrating a range of delay for various users in accordance with an embodiment of the present invention; and

FIG. 7 depicts exemplary ground coverage patterns in accordance with an embodiment of the present invention.

To facilitate understanding identical reference numerals have been used, where possible, to designate identical elements that are common to the figures.

### DETAILED DESCRIPTION OF THE INVENTION

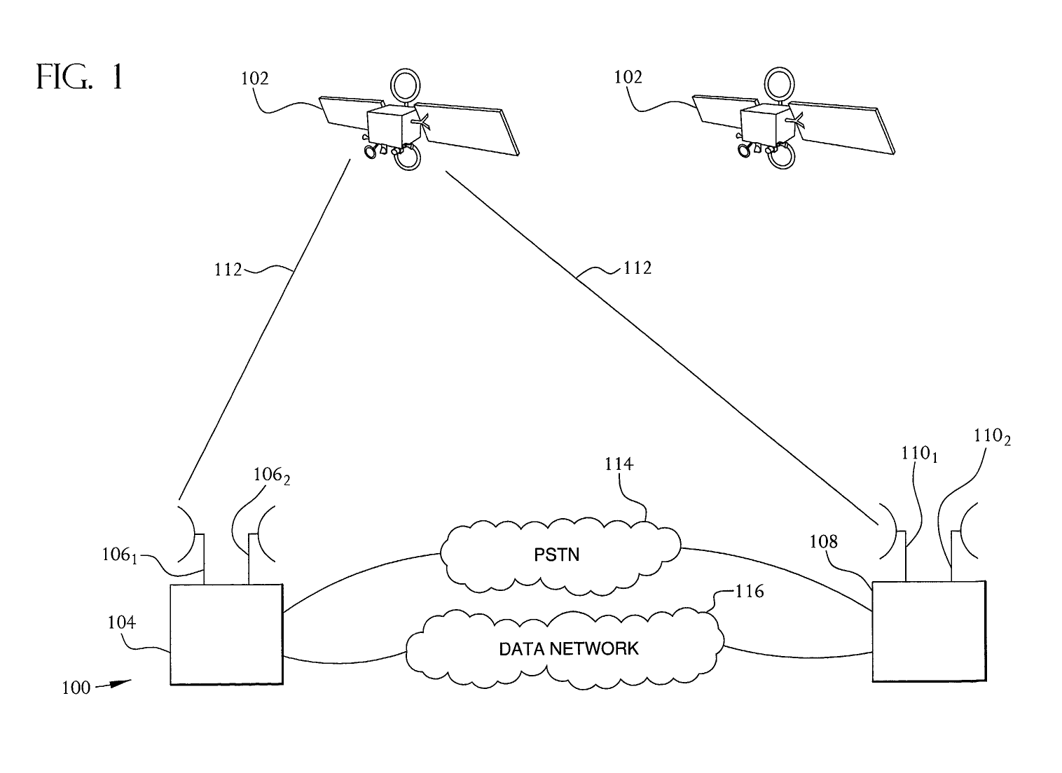

FIG. 1 depicts an illustrative embodiment of a non-geosynchronous satellite communication system 100 for providing single hop communication service in accordance with an aspect of the present invention. Specifically system 100 comprises a plurality of satellites 102₁ up to 102_{N}, a first gateway station 104 including antennas 106₁ and 106₂ (hereinafter referred to as antennae 106), a second gateway station 108 including antennas 110₁ and 110₂ (hereinafter referred to as antennae 110 ), spot beams 112, a public switch telephone network (PSTN) 114 and a data network 116.

The gateways 104 and 108 interface with the terrestrial telephony carrier, such as PSTN 114, a data network 116, and can also interface with a conventional wireless network such as Global System for Mobile Communications (GSM). Accordingly, users may place calls using either the landline or GSM network.

An embodiment of the present invention operates to provide longitude independent single hop communications between two gateway stations 104 and 108. The two gateway stations 104 and 108 can be separated by as much as 180° in longitude. The plurality of satellites 102 are placed in a polar orbit with the satellites 102 passing over the north and/or south pole. The orbit can be either an elliptical orbit, for example, a high elliptical orbit (HEO), or a circular orbit. The elliptical orbit requires the least amount of satellites for continuous polar coverage. As few as three satellites are required to provide continuous coverage for an elliptical orbit.

It will be appreciated by those skilled in the art that although the present invention is described in the context of an elliptical orbit, the present invention can be applied to a circular orbit. However, the number of required satellites for a circular orbit will vary from that of an elliptical orbit. For instance, a satellite system having a circular orbit typically requires about 6 to 8 satellites to provide continuous coverage for a polar orbit.

For a communication system 100 comprising three satellites, it takes each one of the plurality of satellites 102 about twelve hours to orbit the pole. The altitude of the apogee or high point of the plurality of satellites ranges from about 35,500 to 47,000 km. A preferable apogee for the present invention is about 39,000 km. At about 39,000 km and at about 78° north latitude, the satellite 102 is considered to be in the active portion of its orbit. During the active portion of the orbit, about a third of the earth is visible to the satellite 102. Specifically, the satellite 102 has reached the peak of its orbit and the earth is visible so that one third of the globe surrounding the north pole is visible to satellites 102. More specifically, countries and continents on opposite sides of the globe are visible to the satellite 102. This allows the satellite 102 to provide transpolar communication. For example, a subscriber in New York can make a call to Beijing, China in a single hop because both cities fall within the spot beams 112 of satellite 102.

Each one of the plurality of satellites 102 is in the active portion of its orbit for about four hours for a three satellite HEO system. As satellite 102 exits the active portion of its orbit, the satellite 102 hands the call off to another satellite that is entering or is in the active portion of its orbit. Since it takes about twelve hours for a satellite to complete its orbit, the satellite 102 that hands off the call will not begin the active portion of its orbit again until about nine hours later. Thus, three satellites are required to provide continuous coverage for a polar orbit of the globe (earth).

The satellite 102 can operate at maximum efficiency 24 hours a day due to being time zone independent. For example, the satellite's 102 spot beams 112 can cover different time zones. In other words, since satellite's 102 spot beams 112 cover multiple time zones simultaneously, satellite 102 preferably will not encounter significant slow periods. For example, when it is evening in one time zone, traffic tends to be light because many people are asleep. However, traffic tends to be heavier during the day when people are awake. Satellites that are limited to a single regional area can not achieve maximum efficiency due to the differences in time zones over a 24 hour period.

For a three satellite system, each gateway station 104 and 108 requires two tracking antennas 106 and 110 each. The gateway stations 104 and 108 are preferably located within a latitude of about 25° to 30° north and preferably point to the north pole. At about 30° north pole is visible to satellites 102. More specifically, countries and continents on opposite sides of the globe are visible to the satellite 102. This allows the satellite 102 to provide transpolar communication. For example, a subscriber in New York can make a call to Beijing, China in a single hop because both cities fall within the spot beams 112 of satellite 102.

Each one of the plurality of satellites 102 is in the active portion of its orbit for about four hours for a three satellite HEO system. As satellite 102 exits the active portion of its orbit, the satellite 102 hands the call off to another satellite that is entering or is in the active portion of its orbit. Since it takes about twelve hours for a satellite to complete its orbit, the satellite 102 that hands off the call will not begin the active portion of its orbit again until about nine hours later. Thus, three satellites are required to provide continuous coverage for a polar orbit of the globe (earth).

The satellite 102 can operate at maximum efficiency 24 hours a day due to being time zone independent. For example, the satellite's 102 spot beams 112 can cover different time zones. In other words, since satellite's 102 spot beams 112 cover multiple time zones simultaneously, satellite 102 preferably will not encounter significant slow periods. For example, when it is evening in one time zone, traffic tends to be light because many people are asleep. However, traffic tends to be heavier during the day when people are awake. Satellites that are limited to a single regional area can not achieve maximum efficiency due to the differences in time zones over a 24 hour period.

For a three satellite system, each gateway station 104 and 108 requires two tracking antennas 106 and 110 each. The gateway stations 104 and 108 are preferably located within a latitude of about 25° to 30° north and preferably point to the north pole. At about 30° north latitude the minimum angle of elevation for the antennas 106 and 110 is about 10° . However, the present invention can provide communication between any two gateways having latitudes greater than 25° and any longitude and a minimum angle of elevation of at least 5°.

The changing in tracking of the satellites 106 and 110 is preferably about a 12° change in latitude over an hour and a half period. The change in tracking for the longitude is about 135° for about a three hour period. Since required tracking for the present invention is slow, antennas 106 and 110 can mechanically track satellites 102.

The present invention provides efficient use of available bandwidth by utilizing the same frequencies used by geosynchronous satellites. Specifically, antennas 106 and 108 point away from the geosynchronous satellites. More specifically, the antennas 106 and 108 point in the opposite direction from the geosynchronous satellites. Thus, the C, Ku and/or Ka frequency bands assigned to geosynchronous satellites can be used by the present invention without causing interference to a geosynchronous satellite system.

The present invention also provides single hop communications between two gateway stations separated by as much as 180° latitude with a delay of about 250 to 280 milliseconds. This is equivalent to a single hop delay of a geosynchronous satellite system providing regional service.

Table 1 depicts exemplary data for a three satellite system. It will be appreciated by those skilled in the art that these values are not absolute and the values listed in the Table 1 can vary from those listed.

TABLE 1

| | |
|---|---|
| Number of Planes | 1 |
| Satellites per Plane | 3 |
| Apogee (km) | 39117.23 |
| Perigee (km) | 1238.17 |
| Time Period (hours) | 11.96 |
| Eccentricity | 0.71 |
| Semi major axis (km) | 26555.70 |
| Mean Anomaly | 164.81°/195.19°/355.27° |
| Argument of Periapsis | −90° |
| Service Time per Satellite | 4 hours |
| Coverage Region (10° elevation) | 35° latitude and above |
| Coverage Region (5° elevation) | 29° latitude and above |

In a second embodiment of the present invention, a four satellite system is provided. Each satellite 102 in a four satellite system completes its orbit in about 12 hours. However, the active portion of the orbit is about three hours. The four satellites 102, together, provide continuous coverage.

In addition, the gateway stations 104 and 108 preferably require a single antennae 106₁ and 110₁ respectively. The handoff for a four satellite system can be completed within the beam width of a gateway station 104 and 108. Therefore only one antennae is required for satellite tracking. In other words, the satellites 102 are in closer proximity to one another than in a three satellite system. Therefore, the handoff between a satellite entering the active portion of its orbit (ascending) and a satellite exiting the active portion of its orbit (descending) occur within the beam width of the gateway stations 104 and 108 respective antennas 106₁ and 110₁. Thus, only a single antennae 106 and 110 is required to track the satellites 102 in the active portion of its orbit.

For the four satellite system, the satellites 102 are placed in two orbital planes separated by about 4° with each plane containing two satellites 102 respectively. Table 2 lists the values for various positions of the satellites 102 and antennas 106 and 110 for a four satellite system.

TABLE 2

| | |
|---|---|
| Number of Planes | 2 |
| Satellites per Plane | 2 |
| Apogee (km) | 39117.23 |
| Perigee (km) | 1238.17 |
| Time Period (hours) | 11.96 |
| Eccentricity | 0.7132 |
| Semi major axis (km) | 26555.70 |
| Mean Anomaly (plane 1) | 168.88°/227.02° |
| Mean Anomaly (plane 2) | 191.11°/132.97° |
| Angle Between Planes (degrees) | 4° |
| Argument of Periapsis | −90° |
| Service Time per Satellite | 3 hours |
| Coverage Region (10° elevation) | 30° latitude and above |
| Coverage Region (5° elevation) | 25° latitude and above |

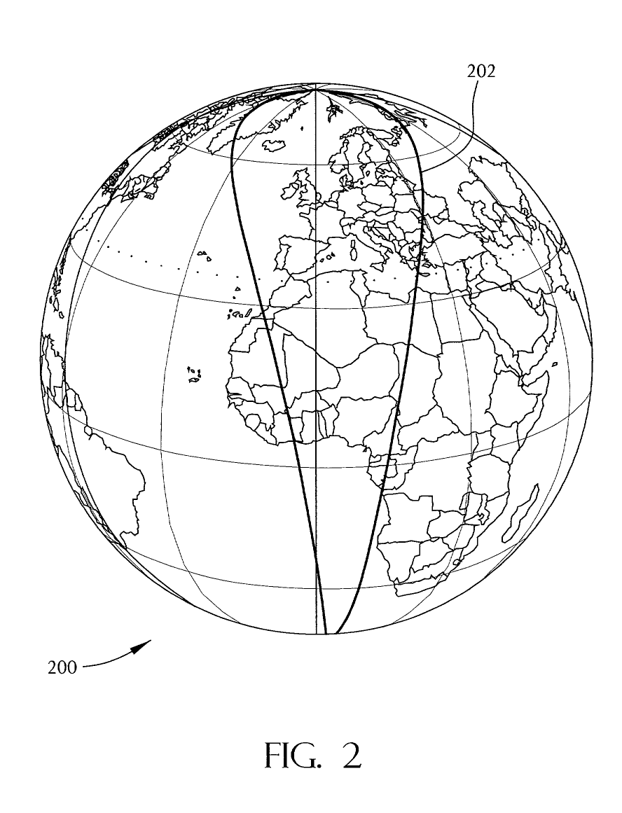

The present invention will now be discussed with reference to FIG. 2 which depicts a trace of a transpolar satellite 102 in accordance with an embodiment of the present invention. Specifically, the transpolar satellite coverage 200 diagram depicts trace 202. More specifically, trace 202 shows the coverage of a transpolar satellite 102. Although not shown, satellite 102 would be at its apogee above the North pole. Similarly, a trace on the opposite side of the globe which mirrors trace 202 exists but is not shown. A discussion of trace 202 is also applicable to the trace not shown on the opposite side of the globe.

Trace 202 is wide on top, but tapers off as it approaches the South pole. It is assumed that traffic is heavier between the equator and the North pole than between the South pole and the equator. Therefore communication system 100 can adequately meet the needs of users between the equator and the North pole. However, if service is desired between the South pole and the equator, a three or four satellite system can be implemented to provide coverage between the equator and the South pole. Rather than the satellites 102 reaching their apogee over the North pole, they will reach it over the South pole.

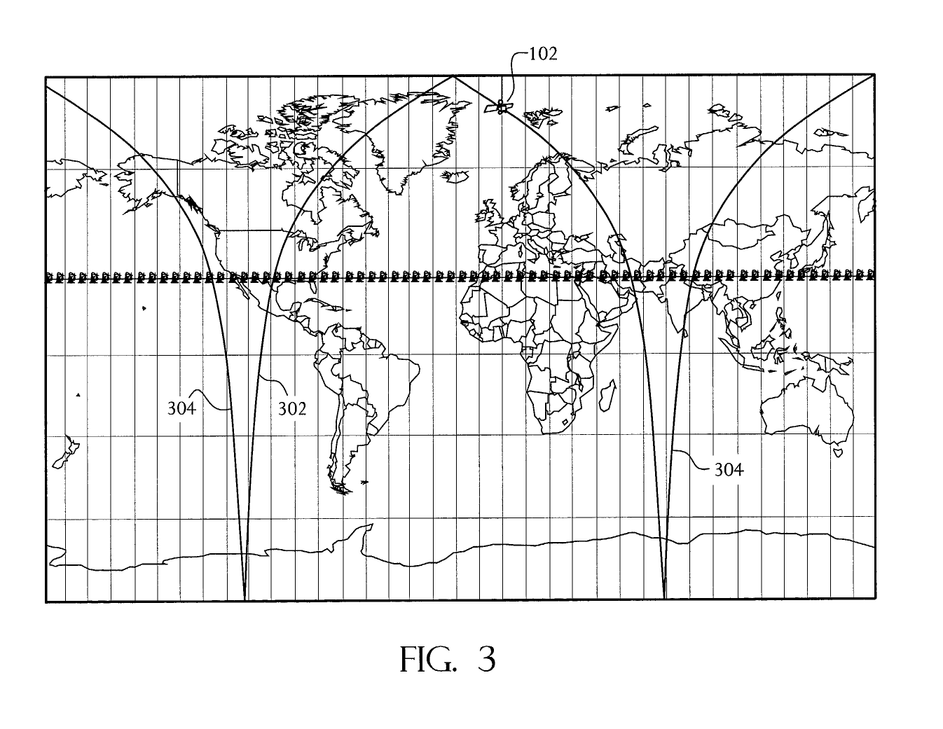

FIG. 3 depicts a ground trace of a transpolar satellite 102 in accordance with an embodiment of the present invention. Ground trace 300 shows the coverage of each satellite 102. Specifically, ground trace 300 depicts the transpolar coverage of satellite 102. Trace 302 shows coverage for a portion of the United States and Europe. Trace 304 is shown as having two portions. However, the two portions of trace 304 when combined make a whole trace.

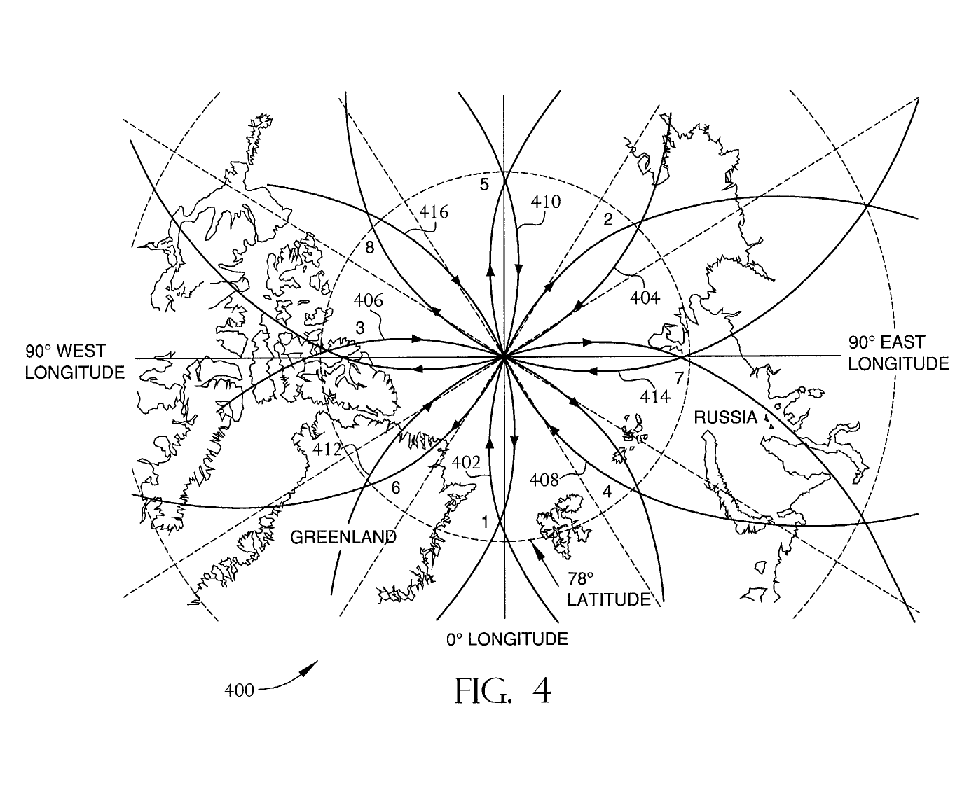

FIG. 4 depicts a hand-off diagram of a transpolar constellation in accordance with an embodiment of the present invention. Specifically, FIG. 4 depicts a hand-off diagram of a transpolar constellation 400 having four satellites 102. The active portion of the satellites' orbits is defined by the 78° latitude circle in FIG. 4. Each point, for example points 1-8, near the circumference of the circle defines either an exit or entrance point for the four satellites 102. The traces show the preferable east-west and north-south tracking of gateways 104 and 108. There are four entrance points and four exit points with the arrows indicating the direction of the orbit for each satellite. For example, a satellite 102, for trace 414, can enter the 78° latitude circle at point 7 and exit at point 8. At point 8, a handoff will occur for a satellite 102 following trace 416. Thus, constant communication can be maintained over the active portion of a satellites orbit. Eight handoffs occur over a 24 hour period for a four satellite system. As previously discussed, at a satellites' 102 apogee, a third of the globe can be viewed. It will be appreciated by those skilled in the art that FIG. 4 is for illustrative purposes and does not detail all of the countries that fall within the scope of the 78° latitude circle.

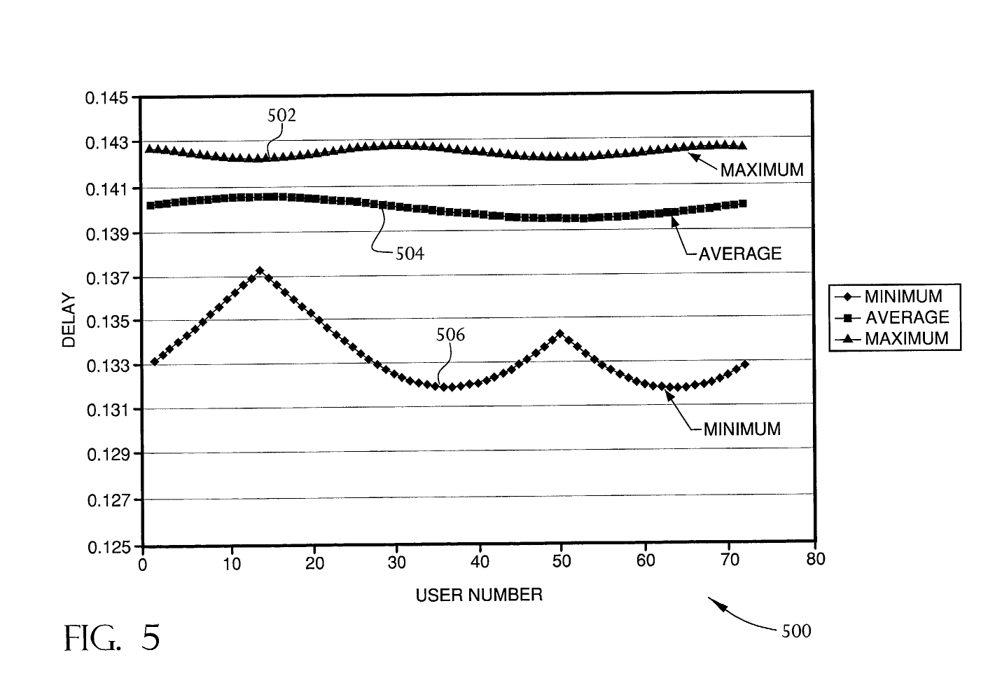

FIG. 5 depicts a graph 500 illustrating a range of elevation angles compared to longitudinal angles in accordance with an embodiment of the present invention. Specifically, graph 500 shows a range of elevation angles Vs longitude for a four satellite system for an earth station at 30° north latitude. As satellites 102 orbit the earth, the elevation angle changes from a minimum to a maximum. The change in elevation angle is a function of longitude. For plot 502, the angle of elevation is at a maximum at about 35° . However, the angle of elevation ranges from about 10° to about 35° for a longitude range of about −175° to +175°. The angle of elevation for plot 506 is at a minimum at about 10° elevation. The angle of elevation for plot 506 ranges from about 10° to 23° for a longitude range of about −175° to +175°. Plot 504 is a relatively level plot. The angle of elevation varies from about 20° to 25° for a longitude range of about −175° to +175°. The measurements were taken when the satellites 102 were at a specific position. The variations between the three plots are due to the earth rotating simultaneously with the satellites 102. Thus the satellite planes can be at right angles or fall somewhere in between 90° and 0° with respect to the location of the earth station.

Although graph 500 shows 10° as the minimum angle of elevation, the invention can be operated at lower elevation angles by using larger antennas. However, the lowest angle of elevation is 0°.

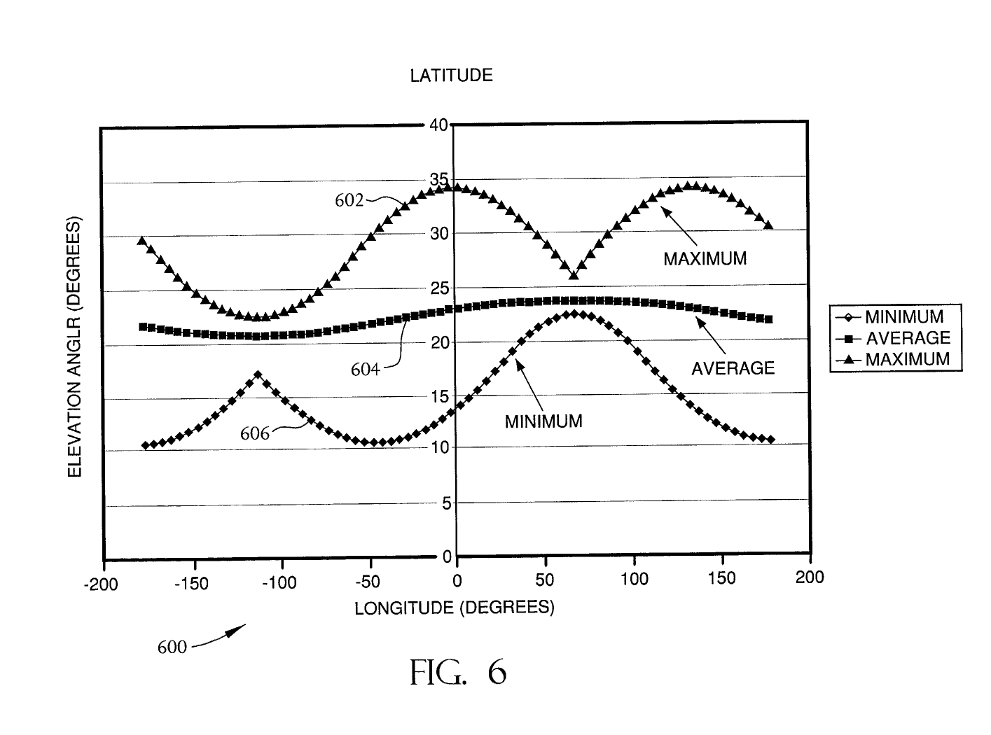

FIG. 6 depicts a graph 600 illustrating a range of delay for various users in accordance with an embodiment of the present invention. Graph 600 illustrates the propagation delay for a four satellite system between the earth station and the satellite, for an earth station located at 30° north latitude. Plot 602 illustrates the maximum delay. Maximum delay can occur when the two gateways 104 and 108 are 180° apart and the satellite 102 is at its maximum height above the north pole. The distance the signals have to travel between the gateway stations 104 and 108 and the satellites 102 are at a maximum at this position.

Plot 606 illustrates minimum delay for system 100 which can occur when the gateways 104 and 108 and the satellite 102 are on the same side of the globe or pole. Depending on the height of the satellite 102 over the pole, delay can be as low as about 130 milliseconds. Plot 604 illustrates average delay which is about 140 milliseconds. This delay is comparable to that of a geosynchronous satellite which can have delay as high as 150 milliseconds.

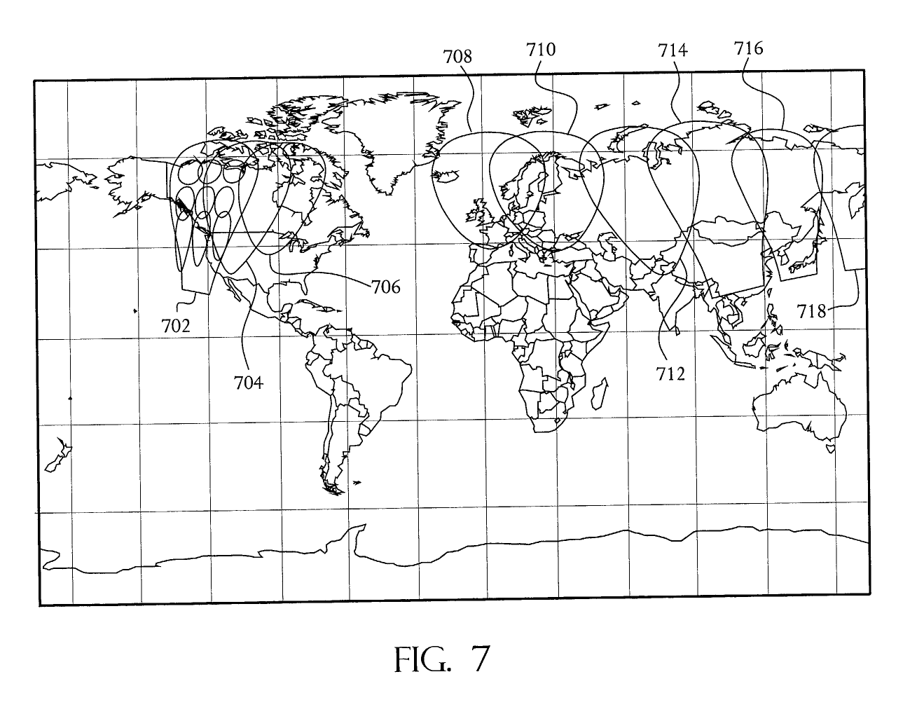

FIG. 7 depicts exemplary ground coverage patterns in accordance with an embodiment of the present invention. Specifically, image 700 depicts the ground coverage for satellites 102. More specifically, C-band frequencies can be used which would provide 500 MHz of bandwidth in each of two polarizations. The antennae pattern can include nine regional beams in longitude. Three of the beams, illustratively 702, 704 and 706, provide coverage to North America. Beam 708 provides coverage for Western Europe. Beam 710 provides coverage for Central Europe and the Middle East. Beam 712 provides coverage for Western Russia, Turkey and surrounding areas. Beam 714 provides coverage for Eastern Russia, China and surrounding areas. Beams 716 and 718 provide coverage for the Pacific Rim area.

In a further embodiment of the invention, each of the beams can be subdivided in latitude to have 5° beams preferably from about 25° to 50° north latitude. 8° beams preferably from about 50° to 66° north latitude, and a 15 ° beam preferably from about 66° to 81°. In still a further embodiment of the invention, one global beam can be added in addition to the 82 beams providing global coverage.

It will be appreciated by those skilled in the art that the above mentioned embodiment can utilize other frequencies besides C-band and utilize other antennae patterns and still fall within the scope of the present invention.

Those skilled in the art can now appreciate from the foregoing description that the broad teachings of the present invention can be implemented in a variety of forms. Therefore, while this invention can be described in connection with particular examples thereof, the true scope of the invention should not be so limited since other modifications will become apparent to the skilled practitioner upon a study of the drawings, specification and the following claims.

What is claimed is:

1. A satellite communication system, comprising:
at least one gateway station;
at least one satellite having a polar orbit, said at least one satellite adapted to provide single hop transpolar communication between two gateways separated by as much as 180° in longitude; and
at least one antenna connected to said at least one gateway station for tracking said at least one satellite.

2. The system of claim 1, wherein said polar orbit includes an active portion, said portion defined by 78° latitude.

3. The system of claim 1, wherein said polar orbit comprises an elliptical orbit.

4. The system of claim 1, wherein said polar orbit comprises a circular orbit.

5. The system of claim 3, wherein said communication system comprises four satellites.

6. The system of claim 1, wherein an apogee for said system is about forty thousand kilometers.

7. The system of claim 1, wherein said two gateways are located within a latitude of about 25° to 30° north.

8. The system of claim 1, wherein said at least one antennae has a minimum angle of elevation of at least 5°.

9. The system of claim 1, wherein a propagation delay between two gateway stations for said system ranges from about 250 to 300 ms.

10. The system of claim 1, wherein said at least one antennae points toward a pole of the earth.

11. The system of claim 10, wherein said pole comprises at least one of:
a south pole; and
a north pole.

12. The system of claim 1, wherein a frequency of said at least one antennae comprises at least one of
a C band frequency;
a Ku band frequency; and
a Ka band frequency.

13. The system of claim 1, wherein said satellite comprises a transpolar satellite.

14. The system of claim 1, wherein said satellite system comprises three satellites.

15. The system of claim 13, wherein said satellite system comprises a pair of antennas connected to said gateway for tracking said satellites.

16. The system of claim 4, wherein said satellite system comprises at least six satellites.

17. A method of providing trans-polar satellite communications coverage for the earth, comprising:
providing at least one gateway station;
providing at least one satellite having a polar orbit, said at least one satellite adapted to provide single hop transpolar communication between two gateways separated by as much as 180° in longitude; and
providing at least one antenna connected to said at least one gateway station for tracking said at least one satellite.

18. The method of claim 17, wherein said polar orbit includes an active portion, said portion defined by 78° latitude.

19. The method of claim 17, wherein said polar orbit comprises an elliptical orbit.

20. The method of claim 17, wherein said polar orbit comprises a circular orbit.

21. The method of claim 19, wherein said communication system comprises four satellites.

22. The method of claim 17, wherein an apogee for said system is about forty thousand kilometers.

23. The method of claim 17, wherein said two gateways are located within a latitude of about 25° to 30° north.

24. The method of claim 17, wherein said at least one antennae has a minimum angle of elevation of at least 5°.

25. The method of claim 17, wherein a propagation delay between the two gateway stations for said system ranges from about 250 to 300 ms.

26. The method of claim 17, wherein said at least one antennae points toward a pole of the earth.

27. The method of claim 17, wherein said pole comprises at least one of:
a south pole; and
a north pole.

28. The method of claim 17, wherein a frequency of said at least one antennae comprises at least one of
a C band frequency;
a Ku band frequency; and
a Ka band frequency.
